(19) United States
(12) Patent Application Publication
(10) Pub. No.: US 2015/0118051 A1
(43) Pub. Date: Apr. 30, 2015

(54) WIND SAIL RECEPTOR

(71) Applicant: Richard A. Steinke, Boulder City, NV (US)

(72) Inventor: Richard A. Steinke, Boulder City, NV (US)

(21) Appl. No.: 14/067,350

(22) Filed: Oct. 30, 2013

(51) Int. Cl. F03D 1/06

(52) U.S. Cl. CPC F03D 1/06
USPC 416/132 B

(57) ABSTRACT

An improved wind sail receptor for turning in a wind flow to turn an axle that operates a generator to produce an electrical power output for performing work. With the improved wind sail receptor blade design and the inclusion of a unique shape of nose cone fitted over a forward end of a housing that the wind sail receptor is journaled to, the wind sail receptor provides for a nearly one hundred percent utilization of the entering wind flow energy to turn the wind sail receptor blades. This near perfect wind energy utilization is provided by the structure of the blades leading and trailing edges along with the blades uniform curvature between leading and trailing edges that is from seventy to seventy eight degrees of arc and the nose cone configuration, whereby a turbulence free wind flow passed off of the blades trailing edge is at a approximately a forty five degree angle to the entering wind flow.

### BACKGROUND OF INVENTION

1. Field of The Invention

This invention pertains to wind mill blades that are for mounting onto an axle to turn in a wind and produce a power output for doing work, with the combination of the blade design and a nose cone directing an air flow into the blades providing a very efficient conversion of the wind energy into blade turning.

2. Prior Art

The present invention is in a new and substantially more efficient wind powered blade structure than any presently available wind mill blade or blades arrangement. Specifically, the present invention is an improvement over an earlier wind sail receptor that the inventor is a joint inventor of, set out in U.S. Pat. No. 7,309,213. Unique to the invention, the blades of the improved wind sail receptor are formed separately as flat segments for mounting between rear and forward hubs, forming a wind sail receptor having three to five blades, depending upon the diameter of the hub the blades are mounted to. The individual blades are each bent between forward and rear hubs to have a leading edge from the forward hub that faces into the wind, and are curved across a cylinder whose ends the forward and rear hubs are mounted to, forming a blade trailing edge. The blades are bent between the leading and trailing edges in a uniform arc and provides a smooth turbulence free wind transition where the wind flow exits off the blades trailing edges at approximately a forty five degree angle downwardly to the direction the entering wind. Which wind flow redirection turns the wind sail receptor blades that are mounted on an axle that turns a generator.

The spacing of the blades around the hub and the bend angle of each blade provides, in practice, for a maximum utilization of the force of the entering wind to translate that wind force into wind sail receptor turning. Further, to provide a maximum efficiency in the utilization of the energy of the wind flow into the wind sail receptor, the invention includes a nose cone, that is fitted over a forward end of a wind sail receptor housing. Which nose cone has a cylindrical shape and slopes outwardly from a rounded dome end to an open base end that mounts across the front or wind facing end of the housing and contains a generator that is axially connected to be turned by wind sail receptor turning, with the wind sail receptor journaled to turn freely on the housing rear end. Which nose cone slope and the radius of the rounded dome end are selected to provide for a translation of wind striking the nose cone and direct it over the rounded top end and along a nose cone cylindrical section, and along the housing surface and into the wind sail receptor blades to turn the wind sail receptor blades, without a creation of turbulence in the wind flow entering the wind sail receptor.

A wind flow passing over the nose cone travels along the housing, that is pivot mounted to the top of a vertical pole, and into the wind sail receptor blades that are thereby turned into that wind flow, without a necessity for a rudder, or like device to turn the wind sail receptor into the wind, causing the wind sail blades to always face directly into the wind flow.

So arranged, the combination of the unique blade design and arrangement of the nose cone provide for an essentially turbulence free passage of a wind flow through the wind sail receptor to capture most, if not all of that wind flow energy, and convert it into torque turning the wind sail receptor blades that are axially connected to turn the generator contained in the housing.

Heretofore, wind mill blade configurations have generally lack efficiency, particularly the blades as are turned in a wind farm operation, that operate at only an efficiency of approximately twenty (20), and thereby utilize only a small percentage of the energy of a wind energy passing through the blades. Which wind farm blades, therefore, have to be large to produce a worthwhile energy output. In fact, even the wind sail receptor of applicant's prior patent could only obtain an efficiency of approximately ninety (90) per cent utilization of wind energy at winds of from eight (8) to ten (10) miles per hour and greater.

The wind sail receptor blades arrangement, because of its size, manner of construction and assembly is far less expensive to construct and maintain over earlier and present wind mills, and is therefore a significant improvement over earlier wind powered systems.

### SUMMARY OF THE INVENTION

It is a principal object of the present invention to provide a wind sail receptor for converting wind power into torque that is applied through an axle of the wind sail receptor to turn a generator for producing electrical energy, whose design provides for a very efficient use of wind energy for turning of the wind sail receptor blades that nears a one hundred percent efficiency.

Another object of the present invention is to provide a wind sail receptor having three to five blades, dependent upon the diameter of the blades hubs, and can be arranged to form six, twelve and up to twenty five foot diameter assemblies that will be significantly smaller in diameter than other wind mill arrangements that produce a like or lesser power output, as compared to the invention.

Still another object of the present invention is to provide a wind sail receptor where the blades are preferably formed and shipped flat for later installation onto a hub arrangement that, accordingly, are inexpensive to manufacture and ship, and can be easily installed and repaired on site.

The present invention is in a wind sail receptor for converting wind energy into electrical power that has three to five blades, depending upon the diameter of forward and rear blade hubs, that can be formed into six, twelve and up to twenty five foot diameter assemblies. In which assemblies, the blades are equally spaced around a rear hub, and are each bent from attachment points at the front face of the rear hub to a forward location on a cylinder, that is proximate to the forward hub, where the rear and a forward hub are connected to opposite faces of the cylinder. Which blade to rear hub connection is at spaced points around the rear hub front face, and the connection to the cylinder is to at least one, and may be to several aligned spaced attachment tabs, that extend outwardly from the cylinder surface, with a forward most connection point being adjacent to the forward hub. In which blade mounting the blade is bent in a uniform curve from leading to trailing edges. Which bend has a uniform curved surface that a wind flow entering the wind sail receptor will travel over from the blade leading to trailing edges, without a creation of turbulence in that wind passage. Which wind flow will exit off of each blade trailing edge at approximately a forty five degree angle to the entering wind flow, without a creation of wind flow separation or turbulence in that exhaust flow as it passes off the blade trailing edge.

The wind sail receptor of the invention includes a nose cone that is secured across a forward end of a housing that has the forward hub mounted to turn freely on the cylinder rear end. Which nose cone has a dome shaped outer end surface and a cylindrical body that connects at a rear surface of the forward end of the housing. The nose cone is formed to provide an even distribution of a wind flow that strikes and travels along the housing, to pass to the forward hub, and travels into the blades. Which wind flow, absent the nose cone, would strike a blunt forward end of the housing and spread outwardly into the wind flow entering the wind sail receptor, negatively affecting wind sail receptor turning efficiency.

The blades of the wind sail receptor are preferably formed individually and each has an inner end attached at forward spaced points to a front surface of the rear hub, and is bent therefrom forward along the outer surface of a cylinder to a point thereof that is proximate to the forward hub. From the rear hub attachment, each blade cylinder mounting end is bent along the cylinder outer surface to a forward attachment tab that is adjacent to the forward hub for attaching the blade to butt against the cylinder outer surface. In which blade to cylinder mounting the blade is bent into an arc of from seventy to seventy eight degrees that provides for a smooth redirection of the entering wind flow that has passed across the nose cone and traveled along the housing, to turn the wind sail receptor blades, translating wind energy into wind sail receptor turning.

Each blade from a second connection to the rear hub has an outwardly curved edge that is the blade trailing edge and is curved from its first inner end connection to fit closely to the cylinder surface and ends in a connection end that couples to a tab that extends outwardly from the cylinder surface, proximate to the front hub and the cylinder end of the blade leading edge. Which blade forward trailing and leading edges, respectively, extend outwardly from the cylinder, and each connects to an opposite end of a straight blade outer end. The blade leading edge, before mounting, is essentially straight. However, when bent, appears to have a curved leading edge, and the trailing edge that is curved outwardly adjacent to the rear hub mounting to a point therealong wherefrom it is essentially straight to is end connection to the blade outer end.

In operation, a wind flow entering the wind sail receptor from the nose cone and across the housing travels over blade essentially straight sloping leading, and is redirected by the blade trailing edge curved section as a smooth non turbulent flow to the blade trailing edge. Which wind flow has passed off of the nose cone and along the housing as a smooth air flow that then travels across the blades leading edge, around the curve of the blades, and exits off of the blades trailing edges as a turbulence free air flow. Which exhaust wind flow is directed downwardly by the blades trailing edges of each blade at approximately a forty five degree angle to the entering wind flow. Which exhaust air flow is turbulence free and provides nearly a one hundred percent efficiency in the conversion of the entering wind flow energy into turning of the wind sail receptor. With the redirection of the entering air flow redirection acting on each blade to translate the wind flow energy into blade movement that turns an axle that is axially connected to the hubs to turn a generator mounted in the housing, converting the energy of the wind flowing into the wind sail receptor into axial torque.

The blade themselves and the other components of the wind sail receptor of the invention are simple and economical to produce, with the blades, preferably manufactured by casting methods, from a polyurethane material and are connected to the rear hub to be equally spaced there around.

In operation, the wind directed across the nose cone and along the housing acts on the wind sail receptor blades to pivot the housing with wind direction changes such that the wind sail receptor will always face into the wind.

### DESCRIPTION OF THE DRAWINGS

The invention may take physical form in certain parts and arrangement of parts, and a preferred embodiment of which will be described in detail in this specification and illustrated in the accompanying drawings which form a part hereof:

FIG. 1 shows a profile perspective view taken from a right side and rear end of a four-blade wind sail receptor of the invention and shows a nose cone fitted over a front end of a housing that is pivot mounted onto a top end of a pole;

FIG. 2 shows a top plan view of a single blade of the wind sail receptor showing the blade as flat and includes blade leading and trailing edges, with a blade outer end connected to the ends of the leading and trailing edges, showing the blade leading edge end as having a radius to fit to a forward face of a rear hub that has end holes formed therethrough that connect to the rear hub forward face, and shows a blade leading edge lower end as including a hole that connects to a connecting tab that extends outwardly from the surface of a cylinder, adjacent to a forward hub rear end, and shows the blade leading edge end bent from the connection to the attitude shown in FIG. 1;

FIG. 3 shows the flat blade of FIG. 2 connected to the front face of the rear hub and is bent from its leading edge at to its connection to the cylinder surface, proximate to the forward hub;

FIG. 4 is a front profile perspective view of the wind sail receptor of FIG. 1, showing the curvature of each blade from leading to trailing edge bent at an angle of 70 to 78 degrees, and shows the nose cone mounted to a housing forward end;

FIG. 5 is a profile perspective view like that of FIG. 1 taken from the rear face of the rear hub connected to rear end of the housing and includes a nose cone installed over the housing forward end, which nose cone has a dome shaped forward end and has a cylindrical body with the surface of that cylinder tapering from a lesser to greater diameter end and is connected to the housing forward end, and shows a wind flow, arrow B, striking the cone nose end that separates and travels down the nose cone sides and into a wind flow A that travels into the blades, showing the joined flows as combining and traveling into the blades;

FIG. 6 is a side elevation view of the nose cone of FIG. 5, showing the nose cone dome radius and the taper of the cylindrical sides from lesser to greater diameters, and shows, as broken arrows B, the wind flow traveling over the dome end and along the nose cone cylindrical body, and shows the nose cone rear end as including threads;

FIG. 6A is a side sectional view of an alternative nose cone connection arrangement that includes a step formed around the housing front end edge whereover the nose cone is fitted and is secured thereto as with screws;

FIG. 7 shows a side elevation view of the wind sail receptor body as a cylinder with attached rear and forward hubs, and shows the rear hub attached to the cylinder rear end with fasteners fitted through spaced holes, less blades, and shows the forward hub journaled to the housing rear end to turn freely, and which housing is shown as pivot mounted to a top end of a pole, so as to allow the wind sail receptor to track into the wind flow; and

FIG. 8 shows the wind sail receptor body of FIG. 7, that includes the wind sail receptor blades mounted thereto, with wind flows A and B, shown in broken lines, into the wind sail receptor from the nose cone.

### DETAILED DESCRIPTION

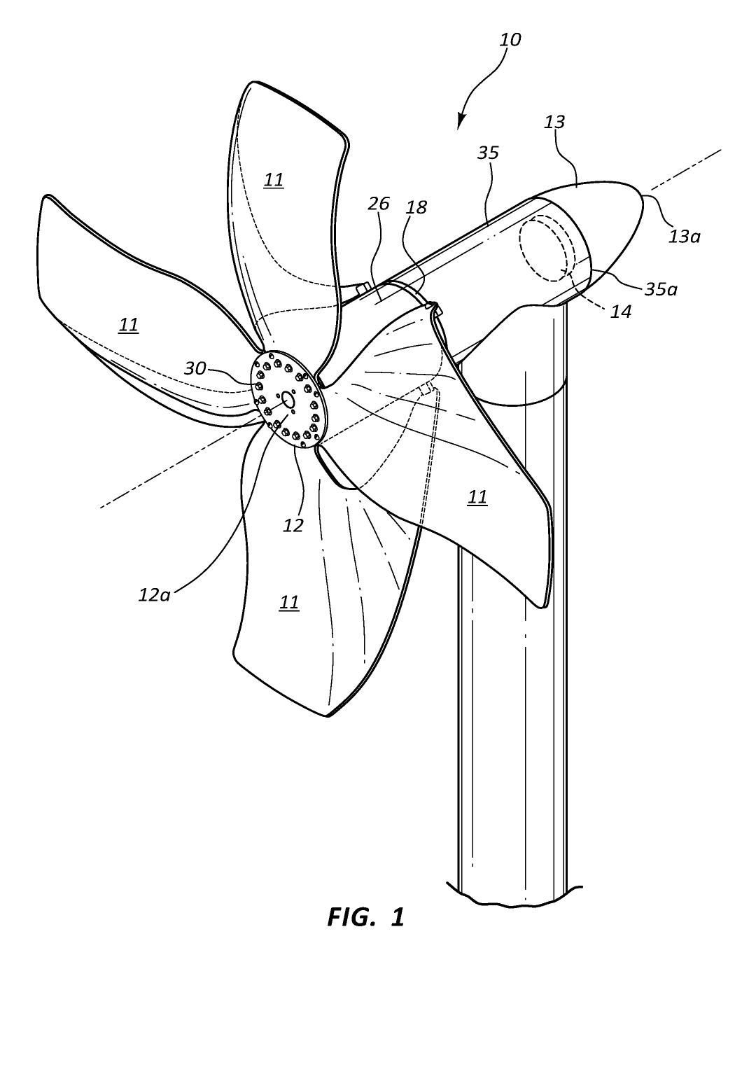

The present invention is in a wind sail receptor 10, shown in FIGS. 1, 3 through 5 and 8, having from three to five blades 11 that are spaced at equal distances around a rear hub 12, where the rear hub 12 diameter is selected to accommodate the chosen number of blades and includes spaced holes 12a appropriate to the number of blades that are attached to a front face of the rear hub, and a preferred four bladed wind sail receptor 10 is shown in FIGS. 1 and 3 through 5. Which Figs. show the like blades 11 attached at equal intervals around the front edge of the rear hub 12, and show the combination of the blades 11 arranged in close spaced proximity to one another and are attached at hub connection ends 15 to the front surface of the rear hub 12.

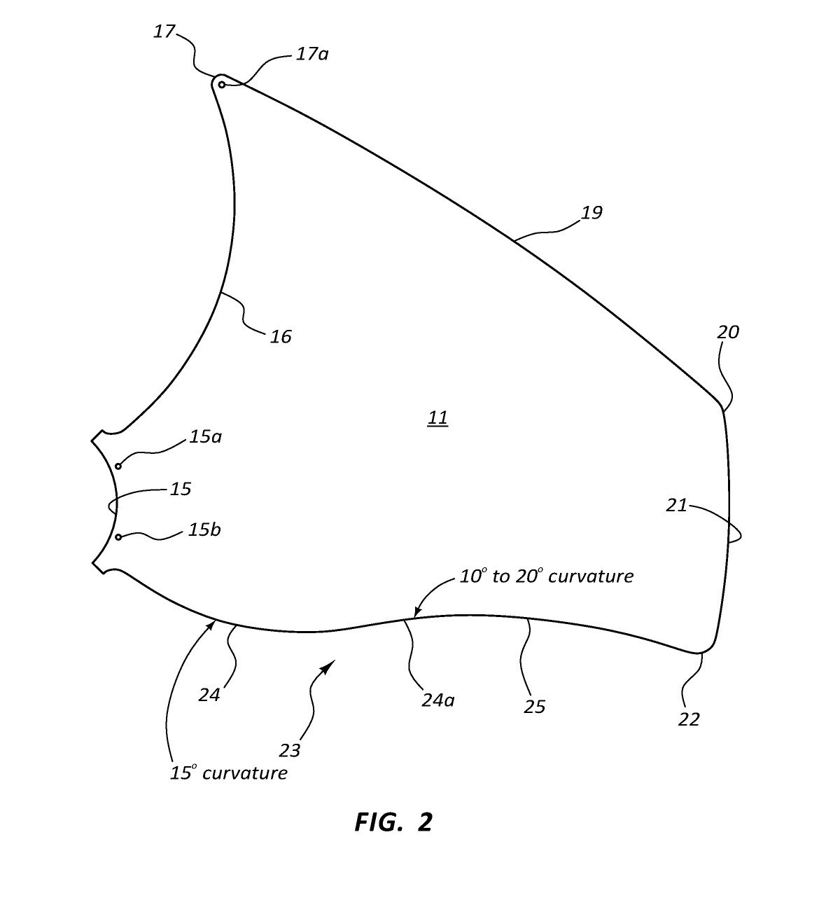

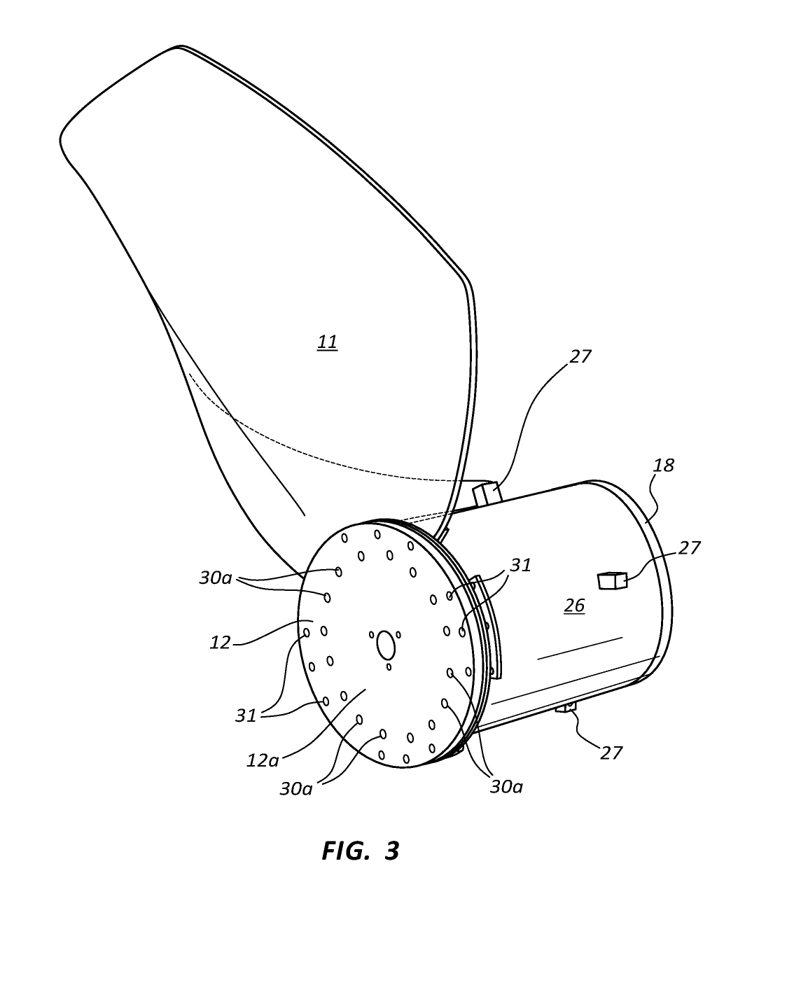

FIG. 2 shows a flat plane view of a preferred blade 11 that is configured to have a curved rear hub connection section 15 that is for attachment, at first and second connection holes 15a and 15b, respectively, to the rear hub 12 front surface, as shown in FIGS. 1 and 3. The blade 11 is shown as having a curved section 16, adjacent to its second connection 15b, that extends to a forward hub 18 connection end 17 and has a connection hole 17a formed therein. Which curved section 16 is formed to conform to the surface of a cylinder 26 that the rear and forward hubs, 12 and 18, respectively, are connected to. Shown in FIG. 2, the blade 11 curved section 15 includes the first and second connection holes 15a and 15b that are proximate to the ends of the arc of the circumference of the rear hub 12 that receive fasteners, such as screws or bolts, that are turned into holes 12a formed through the rear hub 12, shown in FIGS. 1 and 3, for fastening the blade arc section 15 to the forward face of the rear hub 12.

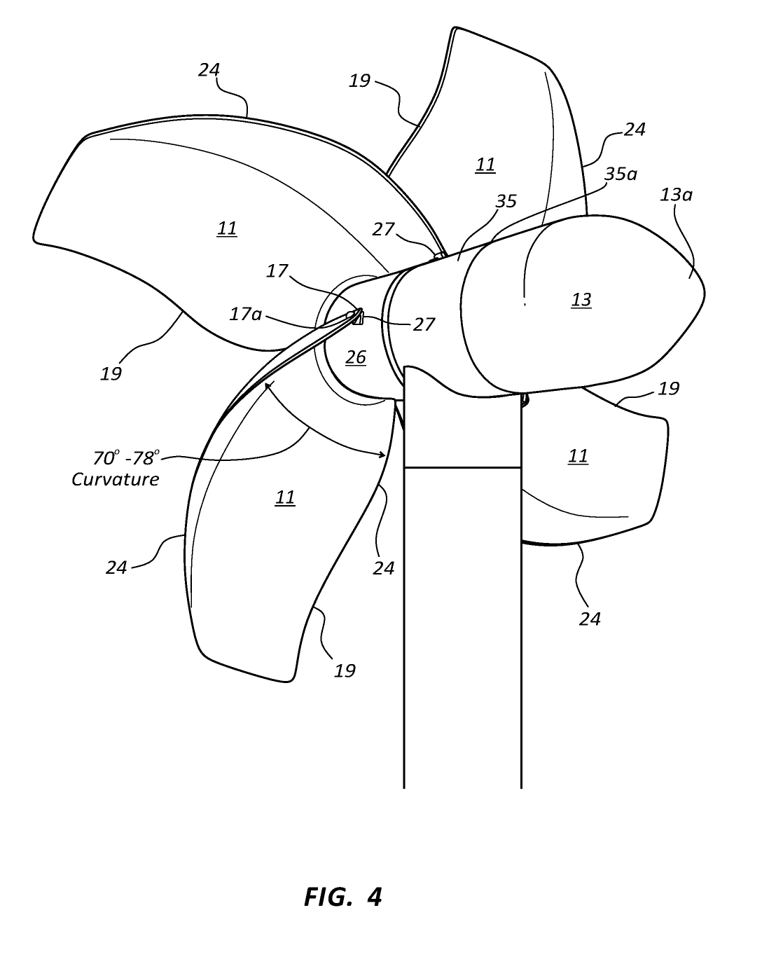

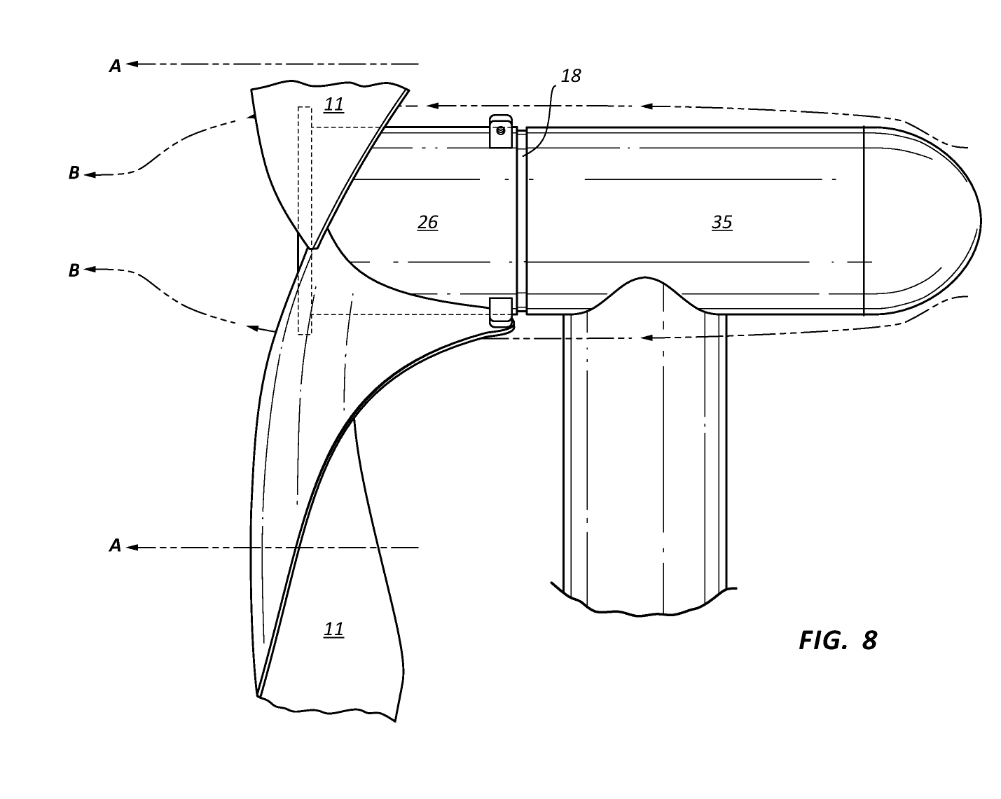

The blade 11 is thereby connected to the rear hub 12 forward face at its arc section 15 by fitting fasteners, such as screws, through the first and second rear hub connection holes 15a and 15b, respectively, into selected rear hub holes 12a. With the blade 11 connected to the rear hub 12, a trailing blade edge 23 is adjacent to the second connecting hole 15b and extends outwardly therefrom. The blade 11 has a curved section 16 that extends from adjacent to the first connecting hole that is for fitting closely to the surface of a cylinder 26, as shown in FIGS. 3 and 8, and terminates in an end 17 that has a connecting hole 17a formed therethrough. Which hole is for alignment with and connection to a tab 27 that projects outwardly from the cylinder surface and is adjacent to a rear surface of forward hub. With the connection of the blade 11 end 17 to the tab 27, the blade curved section 16 will fit closely to the cylinder 26 surface, as shown in FIGS. 4 and 8. With that coupling of the blade end 17 to the tab 26, as shown in FIGS. 4 and 8, the blade 11 is bent into a smooth arc, as discussed below, and a blade leading edge 19 extends outwardly from the cylinder 26, as shown in FIGS. 1, 3, through 5 and 8. So arranged, the blade leading edge and trailing edges 19 and 23, respectively, extend outwardly from the cylinder 26, and each connects to an end of a straight blade end 21.

The curve of the blade inner surface 16 is, of course, dependant upon the diameter of the rear and front hubs, 12 and 18, respectively, and the cylinder 26, and that curve is dependent upon the number of blades 11, whether three to five blades 11 are employed, and the diameter the wind sail receptor 10 across the blades. Also, as shown in FIG. 2, to accommodate the different diameter of hubs and cylinder, the arc section 15 of the blade inner end between the first and second rear hub mounting holes 15a and 15b, is selected to fit snugly to the rear hub 12 and cylinder 26, at connection points 12a.

The blade 11 is bent between the front face of the rear hub 12 to its end connection point 17a and it's coupling at a hole 28 in an end of tab 27, that extends outward from the cylinder 26 surface, into an arc of from seventy to seventy six degrees, whereby a wind striking the blade 11 leading edge 19 will travel, without turbulence, around the blade arc to exit, without turbulence, off of the blade trailing edge 23.

Where a blade 11 single end connection point 17a is shown for connection to the coupling to the single tab 27, it should be understood that additional spaced coupling tabs 27 can be installed onto the cylinder 26 surface, and appropriately spaced holes can be formed along the blade inner surface section 16 that align with to connect to the spaced tabs 27, to provide a reinforcement of the connection of the blade inner surface 16 to the cylinder 26 surface. Such reinforcement, while not required, is useful for adding strength to the blade to cylinder connection, particularly for the twelve and twenty five foot diameter wind sail receptors. Which tab 27 and blade 17 end connection, as shown in FIG. 8, is adjacent to the rear surface of the forward hub 18, as shown in FIGS. 1 and 3.

Shown in FIG. 2, the blade 11 has a sloped front side 19 that terminates in a front tip end 20, which tip end connects to a straight blade end 21, whose opposite end 22 connects to an outer end of blade 11 trailing edge 23, whose opposite end connects to the blade arc section 15, proximate to the hole 15b. Which blade trailing edge 23, as shown in FIG. 2, is curved outwardly at section 24 at an arc of approximately fifteen (15) degrees from its junction with the arc section 15, end, adjacent to hole 15b, with that curve reversed at a distance from the blade trailing edge end 22 that is approximately one fourth to one third the distance from the blade hole 15a to the blade trailing edge end 22 into an inward arc of approximately ten (10) to twenty (20) degrees at a junction 24a to the blade end at 22. So arranged, with the blade 11 attached at connection point 17a to the cylinder 26, at tab 27, that is located proximate to a rear face of the in front hub 18, as shown in FIG. 3, the blade 11 will curve from its leading edge 19 to its trailing edge 23, as shown in FIG. 4. With, as shown in FIG. 4, the blades 11 are bent into a smooth curve or arc of from seventy to seventy eight degrees.

For mounting each blade 11, to the rear hub 12, the rear hub 12 includes spaced holes 12a formed around the rear hub edge that are spaced equidistantly apart and are for alignment with the blade arc section 15 first and second connection holes 15a and 15b to receive fasteners fitted through the blade arc section 15 first and second connection 15a and 15b, respectively, that are turned into the rear hub 12 holes 12a, as shown in FIG. 3.

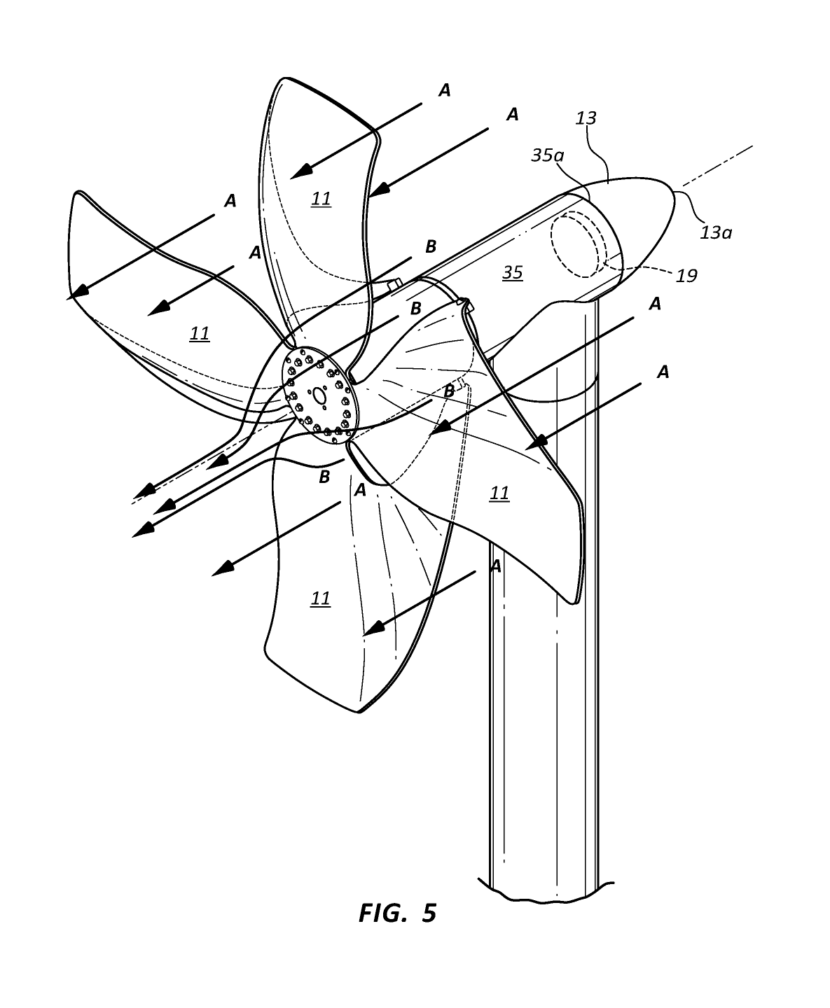

The configuration of the blades 11 provides, as shown in FIG. 5, for receiving a wind flow A that has passed across a nose cone 35 that is secured to a forward end of the housing 27, after that wind flow has travels across the forward hub 16, it travels into and through the blades, converting wind energy into blade turning. Which blades 11 are, as set out above, connected to the rear hub 12, cylinder 26 and forward hub 18, and which hubs 12 and 18 are axially connected to a shaft, not shown, that is fitted to the hubs 12 and 18, and passes through the center of the cylinder 26 and forward hub 18 and connects, to turn, a generator, not shown, that is contained in a housing 35 that is shown in FIGS. 1, 4, 5 and 8, that show the forward hub 18 journaled or pivot connected to which housing rear end. Additionally, FIG. 5 shows a wind flow B that is shown as curving as it passes over the nose cone end 13a and travels over the nose cone 13, to travel along the housing 35, and into the spaced blades 11 of the blade 11 curved portion, as shown in FIGS. 5 and 8. Which wind flow B is thereby directed into the wind flow A that passes over the nose cone 13 and housing 35, with the two wind flows then combining and passing into and through the blades 11, as shown in FIGS. 5 and 8, to turn the blades 11. The combination of the blades 11 leading edge 19 that is curved by the blade 11 connection to the cylinder 25, causes the combined wind flows A and B to travel outwardly from the blade greater to lesser thickness as that combined wind flow A and B travel around the blade arc of from seventy to seventy eight degrees, as shown in FIG. 4, as non-turbulent flows with, the combined wind air flows then passing, turbulence free, off of the blade trailing edge 23. Due to the shape of which blade 11 trailing edge 23, the combined wind flows then travel off of the blade 11 trailing edge 23 as essentially turbulence free flows, as discussed below.

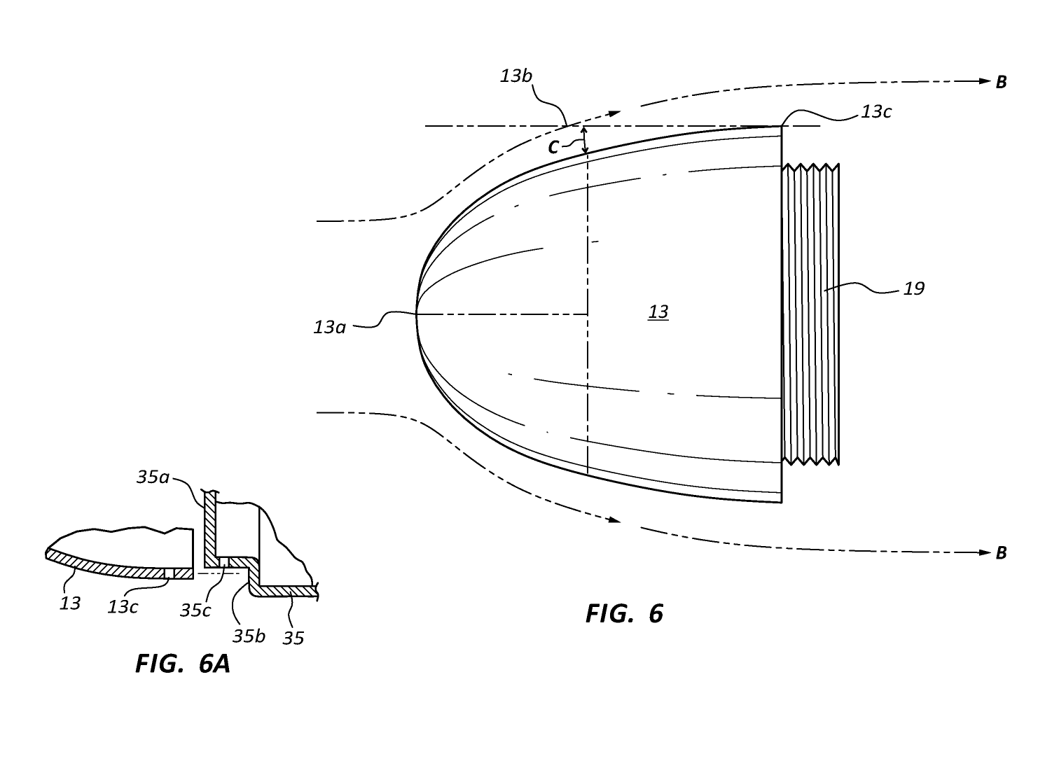

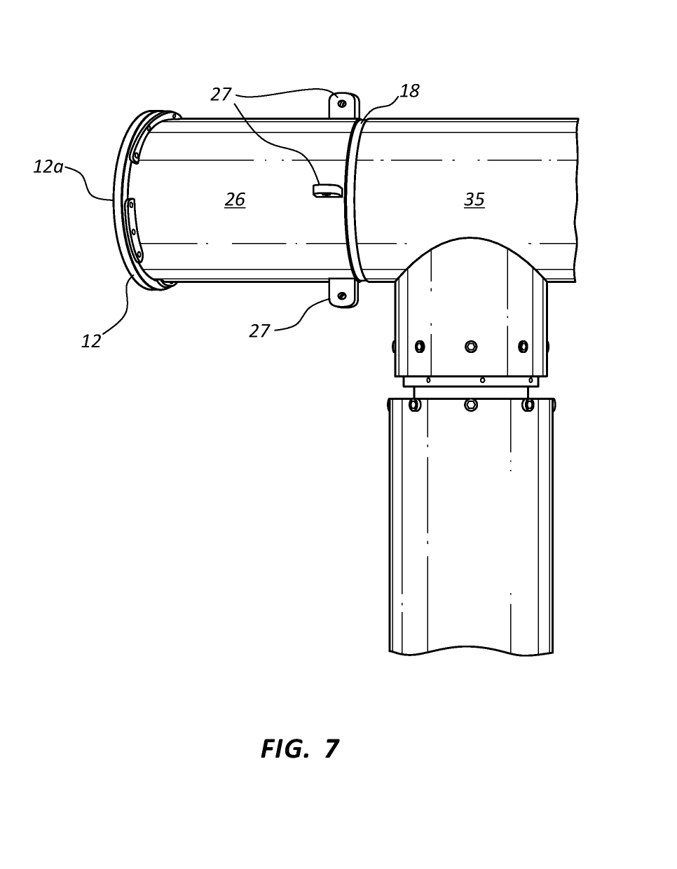

Shown in FIG. 6, the nose cone 13 has a rounded dome shaped forward end 13a and tapers outwardly to its end 13b above a rear threaded section 19. Which threaded section 19 is for turning in a threaded center portion the forward end 35a of the housing, shown in FIG. 5. Though, it should be understood, other coupling arrangements can be utilized for fitting the nose cone 13 onto the housing 35 forward end 35a, within the scope of this disclosure. For example, FIG. 6A shows a side elevation section of forward end 35a of the housing 35 as including a stepped section 35b formed around its circumference, adjacent to the forward end 35a, that the nose cone 13 is aligned to fit over. And the housing 35 stepped section 35b is shown as including threaded spaced holes 35c formed there around that align with spaced holes 13c formed through the nose cone 13, with the holes 35c and 13c each to receive a fastener, such as a bolt fitted thereto, for securing the nose cone 13 onto the housing 35 forward end 35a.

In FIG. 6 the nose cone 13 is shown as tapering tapers outwardly from the junction of the dome to the nose cone side, shown as 13b, to terminate in a nose cone end 13c. Which taper is shown as angle C in FIG. 6, and is an angle of approximately fifteen (15) to thirty (30) degrees. In practice, the radius of the dome from the dome center to side junction 13b is approximately one half of the nose cone diameter, and which ratio can be from three eights to five eights within the scope of this disclosure. So arranged, a wind flow, arrow B, will travel smoothly over the nose cone dome end 13a, along the side of the nose cone 13, across the housing 35 surface, and into the blades 11 at each blade connection point 17a to one of the spaced the tabs 27 that extend outwardly from the cylinder 26 surface, adjacent to the rear face of the forward hub 18. Wind flows A and B, shown in FIGS. 5 and 8, combine and flow into each blade 11, across the blade leading edge 19, and around the blade curve of from seventy to seventy eight degrees, without a creation of turbulence. In operation, the wind flow B combines and consolidates with the wind flow A and travels smoothly without turbulence over the blade surface, transferring the energy in the wind flows into blade turning, and then exhausts across the blade 11 trailing edge 23. Which trailing edge 23, as shown best in FIG. 2, is curved at 24, and that curve is reversed at 24a, to a lesser essentially straight section 25 to the blade end 22. Which curve 24 is extends from the blade rear edge to accommodate the consolidated wind flows A and B so as to discourage turbulence in that combined wind flow that then exhaust off of the blade trailing edge. Which exhaust wind flow continues to be a non turbulent flow as it separates off of the blade trailing edge 23. Which combined non turbulent wind flow travel over the blades 11 and that turbulence is not created in the combined wind flow as it separates off of the blade tailing edge 23 produces a nearly one hundred percent efficiency in wind energy conversion into blade turning. So arranged, the combined wind flows A and B as have been exhausted off of the blade trailing edge 23 travel in a downward direction that is at an angle of approximately forty five degrees to the wind air flow direction into the wind sail receptor.

In practice, the arrangement of the wind sail receptor 10 blades 11 mounted around the rear hub 12, where the blades 11 arc sections 15 are attached to the front face of the rear hub at equal intervals, provides for a secure and durable mounting to the blades 11. So arranged, the combined wind flows A and B enter the blades 11 across the blade leading edge 19 accumulates at the blade trailing edge at curved section 24 to flow outwardly therefrom to where the curve is reversed at 24a and then to the essentially straight section 25, and off from the blade end 22. Which curved section 24 has a greater length of edge to accommodate the combined wind flows A and B as have traveled across the blade 11, and to smoothly exhaust the combined wind flows both across the blade at the curved section 24, without a creating of turbulence and to guide the combined wind flows along the blade to exhaust off of the straight section 25. Which combined wind flow passage off of the blade trailing edge 23 curved and straight sections 24 and 25. In practice, the combination of which curved and straight sections 24 and 25 promotes a non-turbulent separation of the combined wind flow off of the blade trailing edge. Which wind air flow exhaust, because of the trailing edge 23 configuration, is smooth and does not create turbulence as it travels off of the blade trailing edge 23, and this non turbulent wind air flow off the blade 11 at trailing edge separation promotes an efficient translation of the wind flow energy into blade turning with minimum wind energy losses.

Along with the shape of the blade 11 the trailing edge 23, as discussed above, to maximize wind flow energy conversion into blade 11 turning, the bent blade 11 is curved in a uniform arc of from seventy to seventy eight degrees from its leading to trailing edges, 19 and 23, respectively. This smooth curved surface maximizes wind energy conversion to blade turning and provides for a non turbulent wind air flow travel over the blade from leading to trailing edges. As set out above, this preferred uniform arc is formed in the bending of blade 11 from its mounting at blade arc section 15 end connection at holes 15a across the cylinder 25 to the blade end 17 at connection point 17a to the tab 27 that extends outwardly from the cylinder 25, adjacent to the forward hub 18. Which tab 27, shown in FIGS. 1, 3 and 4, is formed to receive the blade end 17 engaging surface and to closely fit thereto. So arranged, the blade 11 curved surface 16, shown in FIGS. 2 and 3 will fit tightly onto the cylinder 25 outer surface. So arranged, a secure coupling of the blade to the rear hub 12 and cylinder 26 is formed that will resist bending when wind energy is directed there against. And, of course, to further strengthen which blade to cylinder coupling, additional tabs 27 can to provided at spaced intervals along the cylinder 25 to align with spaced holes in the blade 17 that receive fasteners to further secure the blade end 17 to the cylinder 25 surface.

While the bend arc can be at an angle of from seventy to seventy eight degrees to produce the wind conversion efficiency, as set out above, for the four bladed six foot diameter wind sail receptor 10 the bent angle is preferably approximately fifteen (15) degrees. Additionally, as shown in FIG. 2, where the curved section 24 of the blade 11 trailing edge 23 has an arc of approximately fifteen (15) degrees, this arc can be from ten (10) to twenty (20) degrees within the scope of this disclosure, and where the point along the arc is reversed, shown at 24a, will be at a distance from the blade trailing edge end 22 that is approximately one fourth to one third of the distance from that blade 11 trailing edge end 22. Also, to provide a close fit of the blade 11 to the cylinder 26 arc the blade curved section 16 to the blade end 17, the curved section will have an arc from fifteen (15) to twenty five (25) degrees, and which arc can vary by plus or minus five (5) degrees, within the scope of this disclosure, depending upon the whether the wind sail receptor has three, four or five blades 11, and the length of the blades 11.

With the blades 11 bent to an arc of from seventy to seventy eight degrees, combined wind flows A and B will smoothly travel around the blade 11 arc and off of the blade trailing edge 23 at an angle of approximately forty five degrees to the direction of the wind flow entering the wind sail receptor 10 that travels over blade leading edge 19, with little or no air flow traveling through the blades 11. This wind flow re-direction provides a maximum utilization of the energy of the wind flow into wind sail receptor turning that closely approaches and one hundred per cent wind energy utilization to turn a generator to produce an electrical power output.

The wind sail receptor 10 is shown herein as having a six foot diameter the rear hub 12, cylinder 26 and forward hub 18 that are approximately one foot in diameter. As set out above, however, the wind sail receptor 10 can be formed to have from three to five blades 11 but such configuration will require an alteration to the hub and cylinder diameter. For example, the hub and cylinder diameter for a five blade 11 wind sail receptor 10 with three foot blades will be approximately fifteen (15) inches, and the hub and cylinder diameter for a three bladed wind sail receptor 10, where the blades are three feet in length will be approximately twelve (12) inches. Additionally, the wind sail receptor 10 can be upscaled with utilization of longer blades 11 and such will also require an alteration in the rear hub 12, cylinder 26 and forward hub 18 diameter. For a wind sail receptor 10 that has twelve foot diameter across the blades ends, utilizing blades 11 that are approximately five feet in length, the hubs and cylinder 12, 18 and 26, respectively, should have approximately a one foot diameter, and, a wind sail receptor 10 with a diameter of twenty five feet across the blades ends, that will utilize blades 11 that are approximately ten feet in length, the hubs and cylinder, 12, 18 and 26, respectively will have a diameter of approximately five feet.

A preferred embodiment of the wind sail receptor of the invention has been shown and described above. It will, however, be apparent to one knowledgeable or skilled in the art that the above described embodiment may incorporate changes and modifications without departing from the general scope of this invention. Which invention is therefore intended to include all such modifications and alterations in so far as they come within the scope of the appended claims and/or a reasonable equivalence thereof.

I claim:

1. A wind sail receptor comprising, a plurality of identical blades that each have leading and trailing edges, where each said blade has a rear hub end for mounting, at first and second blade connection points to a forward face to said rear hub, and said rear hub connects to a cylindrical body rear end, and said cylindrical body is mounted, on a forward end, to a forward hub, and said blade is curved from said first blade connection point to a blade forward end so as to conform to the surface of said cylindrical body and is mounted at said blade forward end to a tab that extends outwardly from said cylindrical body, proximate to said forward hub, and in which blade end mounting to said tab said blade is bent into a uniform curve, and said blade extends outwardly from said cylinder surface to a blade outer end, and which said uniform curve in said blade has an arc of from seventy to seventy eight degrees and terminates in a leading edge of said blade that extends to said blade outer end, and said blade end, opposite to said connection to said leading edge, is connected to said trailing edge of said blade; which said blade trailing edge inner end, from adjacent to said second blade connection point, is curved outwardly at an arc to a point along said trailing edge, where said curve reverses into a straight section that extends to said blade trailing edge connection to said blade outer end; which said forward hub is journaled to turn freely on a rear end of a housing that has a front end that a nose cone is fitted over and said housing is mounted to pivot on a top end of a pole; and which said nose cone has a dome shaped forward surface and cylindrical body, where said nose cone cylindrical body tapers outwardly from its junction with the dome shaped forward surface to the nose cone cylindrical body rear end that is joined onto said housing front end.

2. The improved wind sail receptor as recited in claim 1, wherein the blade leading edge inner end first and second hub connection points are connected to a forward surface of the rear hub.

3. The improved wind sail receptor as recited in claim 1, wherein the blade trailing edge is curved outwardly from adjacent to the blade first hub connection point at an arc of from ten (10) to twenty (20) degrees to the point located along said blade trailing edge whereat said curve reverses and said trailing edges straightens, which said point is approximately one fourth to one third the distance from the trailing edge end to the second blade connection point.

4. The improved wind sail receptor as recited in claim 1, wherein the blade leading edge from its inner end to its trailing edge outer end is sloped inwardly from said leading edge outer end to said leading edge inner end.

5. The wind sail receptor as recited in claim 1, wherein the nose cone cylindrical body taper from its junction with the dome shaped forward end to the nose cone open end has an upward slope of from fifteen (15) to thirty (30) degrees.

6. The improved wind sail receptor as recited in claim 1, wherein the wind sail receptor may be formed with from three to five blades that are secured at equal intervals around a rear hub whose diameter, along with the like diameters of the cylindrical body and front hub, is selected to receive and connect each blade at said rear hub connection points, and to connect to the cylindrical body that connects to the front hub.

7. The wind sail receptor as recited in claim 6, wherein the blades can have a length, taking into account the diameter of the required rear hub, cylindrical body and forward hub that have like diameters, to construct six, twelve and up to twenty five foot diameter wind sail receptors.

8. The wind sail receptor as recited in claim 1, wherein the identical blades are formed flat, by casting methods, from a polyurethane material.

9. The wind sail receptor as recited in claim 1, wherein the nose cone rear end is turned onto a treaded center opening in the housing forward end.

10. The wind said receptor as recited in claim 1, wherein the nose cone rear end is fitted over a stepped end of the housing forward end and fasteners are turned through spaced holes formed around said nose cone rear end and into said stepped end of said housing forward end.

11. The wind sail receptor as recited in claim 1, wherein the wind sail connects to center axle that is fitted through the housing rear end to turn a generator that is arranged in said housing, and said housing is pivotally mounted onto a top of the pole to turn into a wind flow by the action of the wind flow traveling into and to pivot said wind sail receptor into said wind flow.
